(19) United States
(12) Patent Application Publication
(10) Pub. No.: US 2005/0050796 A1
(43) Pub. Date: Mar. 10, 2005

(54) Method for varietal crop seed production and identity preserved grain system

(75) Inventor: Russell LeRoy Wilkin JR., Ft. Wayne, IN (US)

Correspondence Address: JONDLE & ASSOCIATES P.C., 9085 EAST MINERAL CIRCLE, SUITE 200, CENTENNIAL, CO, 80112, US

(73) Assignee: Precision Alliance Group, LLC, Ft. Wayne, IN (US)

(21) Appl. No.: 10/920,896

(22) Filed: Aug. 18, 2004

Related U.S. Application Data
(60) Provisional application No. 60/496,251, filed on Aug. 18, 2003.

(51) Int. Cl. A01C 1/00

(52) U.S. Cl. 47/58.1 SE

(57) ABSTRACT

The present invention provides a system for providing a seed grower with conditioned seed for planting the following cropping cycle from a portion of the harvested crop from a single seed production field. In one embodiment, the system includes an agreement between the seed production company and seed grower to plant and produce a varietal crop for seed purposes with specific genetic characteristics. The seed grower is initially furnished with source seed from the seed production company that matches these specified genetic characteristics and required to meet defined process specifications and results. At appropriate corresponding times during the planting, growing and harvesting processes, a seed production company representative and/or grower may inspect the seed grower's seed source, planting, cultivating, machinery, transport and storage. The results of these inspections, along with recorded seed grower information and data are put into a database which is used to track the criteria the seed grower and seed production company will reference to determine if conditioned seed fulfills agreement specifications. An ensuing agreement is negotiated each subsequent year between the seed production company and the seed grower to allow the seed grower to select a specified conditioned portion of the crop harvested from his/her seed production field for purchasing for planting the following cropping cycle.

### RELATED APPLICATION DATA

This application claims benefit of U.S. Provisional Application Ser. No. 60/496,251, entitled METHOD FOR VARIETAL CROP SEED PRODUCTION AND IDENTITY PRESERVED GRAIN SYSTEM, filed Aug. 18, 2003, which application is incorporated herein in its entirety by reference.

### FIELD OF THE INVENTION

The present invention is directed toward varietal crop seed production, and more particularly toward a method and apparatus for preserving the identity of seed harvested from a portion of a single seed production field.

### BACKGROUND OF THE INVENTION

In varietal crop seed production, seed harvested from multiple seed production fields containing the same variety is often blended together and stored in a single storage unit due to the limited number of storage units on a seed grower's farm. In lieu of storing the seed harvested on a seed grower's farm, the seed harvested from multiple seed production fields may alternatively be transported, blended and stored in a single storage unit at a seed production company due to limited storage capacity at the seed production company. The blending of seed harvested from multiple seed production fields can detrimentally affect the physiological quality, genetic purity and physical purity of the resulting seed. Additionally, the blending of seed may preclude a given seed grower from receiving seed that has the desired physiological quality, genetic purity and physical purity for planting the following cropping cycle. In particular, it is difficult or impossible for a given seed grower to assure that he or she will receive select seed from a portion of a production field, which seed has been properly conditioned, for planting the next year.

Thus, there is a need for a means by which a seed production company can permit a seed grower to purchase conditioned seed from a portion of the crop harvested from a single seed production field for planting by the grower the following cropping cycle. Such a means has advantages to both the seed production company and the seed grower. From the seed production company's viewpoint, the seed selected by the grower will be handled less post-harvest than in the current standard practice in the seed industry and thus reduce the seed production company's costs. For example, the seed industry currently utilizes, in most instances, a multi-tiered distribution chain, which causes increased handling, delivery and storage concerns. From the seed grower's viewpoint, less handling post-harvest will result in less physical damage to the seed and thus increase the chances of higher physiological quality. Less seed handling and segregating harvested seed from each production field will also reduce the risk of cross contamination from not only other crops, but also from different varieties of the same crop.

In addition, a need exists for segregating a high-value crop from a commodity crop, e.g. soybeans which have been genetically modified to produce a herbicide-resistant capability relative to other soybeans. A need exists to prevent such high-value crops from “contaminating” commodity crops and vice versa.

Many types and styles of seed containment units are available to a seed grower. Typically, containment units feature an open top or a hatch on the top which allows direct loading from a combine or associated seed production machinery. Prior art containment units typically do not have the capacity to store and segregate a select portion of seed harvested from a single seed production field. Unloading a prior art seed containment unit can be time consuming and difficult if damage to the contents is to be avoided. The present invention is directed toward overcoming one or more of the problems discussed above.

### SUMMARY OF THE INVENTION

The present invention provides a system for providing a seed grower with conditioned seed for planting the following cropping cycle from a portion of the harvested crop from a single seed production field. In one embodiment, the system includes an agreement between the seed production company and seed grower to plant and produce a varietal crop for seed purposes with specific genetic characteristics. The seed grower is initially furnished with source seed from the seed production company that matches these specified genetic characteristics and required to meet defined process specifications and results. At appropriate corresponding times during the planting, growing and harvesting processes, a seed production company representative and/or grower may inspect the seed grower's seed source, planting, cultivating, machinery, transport and storage. The results of these inspections, along with recorded seed grower information and data are put into a database which is used to track the criteria the seed grower and seed production company will reference to determine if conditioned seed fulfills agreement specifications. An ensuing agreement is negotiated each subsequent year between the seed production company and the seed grower to allow the seed grower to select a specified conditioned portion of the crop harvested from his/her seed production field for purchasing for planting the following cropping cycle.

In another embodiment, the system of the present invention implements paper-based or electronic recording by the seed grower and seed production company of inspection procedures performed before, during and after the varietal crops seed production cycle for legal and historical purposes.

In another embodiment, the present invention provides a system and method for a seed grower and seed production company to enter into specific agreements regarding the production of seed having desired physiological quality and purity, such as seeds per pound, viability and eye appeal. The method also provides for purchasing a specified portion of the resulting crop harvested for planting by the same seed grower the following cropping cycle. To ensure conformance of the seed grower-designated seed to the agreement and other legal requirements, the system provides for inspections at various process points to verify crop data and statistics to the seed grower and seed production company.

In another embodiment, a seed production company negotiates with a seed grower to provide a crop with specific characteristics. The seed grower must be able to provide proof of cropping history. Details regarding the selection of a designated portion of the resulting crop harvested to be used as seed for purchase for planting by the seed grower the following cropping cycle are agreed upon. At all times, the seed production company and seed grower must adhere to the legal requirements of the agreement. Such an agreement requires that specific information regarding the crop be recorded at various times. Examples of the various times where information may be gathered include planting, select crop growth stages, and harvesting. The information is recorded on paper or in electronic form. The information may include details of the source seed provided, variety, acres, description of surround crops, isolation acres, planting method, row width, population planted, soil type, previous crop planted, pounds planted per acre, planting dates, type of fertilizers applied (including rates and dates), type of herbicides applied (including rates and dates), type of insecticides applied (including rates and dates), type of fungicides applied (including rates and dates), field mapping details, rainfall/weather data, inspection dates, equipment sanitation, harvest date, moisture of seed at harvest, yield per acre and sampling of the crop harvested for physiological quality.

In another embodiment, the system may use a seed containment unit to transport the seed grower-designated seed from the seed grower to the seed production company for conditioning. The same containment unit may be used to store or return seed for planting the following crop cycle. This seed containment unit may have unique physical features designed to preserve seed quality by reducing handling and contamination risks, and facilitating loading and unloading.

Another embodiment of the present invention is a seed containment unit having side, front end and rear end walls, a bottom, and a top. These elements of the containment unit define an interior chamber with the bottom forming a floor. The chamber further has an unloading door on at least one of the front end wall and the rear end wall of the containment unit. Also, a loading hatch is movably attached to the top of the containment unit and operable to selectively cover and uncover an opening formed in the top of the containment unit. In addition, the containment unit comprises at least one liner with an air permeable bottom, the liner positioned within the interior chamber whereby seed may be loaded through the top hatch into the first liner through a first opening formed in the liner and unloaded through the rear door through a second opening formed in the liner.

The hatches at the top of the containment unit may be configured to open vertically or slidably, and preferably will be associated with apparatus allowing for the remote opening and closing of the top hatch.

The liner may be fabricated from a substantially vapor tight material, which may be a woven material such as polyethylene or polypropylene. Preferably, the liner will have a closable spout for unloading seed contained within the liner.

In another embodiment, the seed containment unit may feature a second liner positioned adjacent the first liner, each liner being loadable through a separate top hatch. In this embodiment, the invention may have support means within the interior chamber of the seed containment unit positioned between the first and second liners.

In another embodiment, the seed containment unit may further have an aeration tube extending along the floor under any first or second liner contained within the chamber. The aeration tube can, preferably, be selectively connected to a blower for positive or negative aeration and temperature control within the seed containment unit. The aeration tube is preferably a perforated pipe having a round or trapezoidal cross section.

In another embodiment, the seed containment unit may have a temperature monitor to monitor the temperature within the interior chamber. The temperature monitor may communicate with a single monitoring station associated with the seed containment unit, or transmit temperature data to a centralized location through directly wired or wireless communication apparatus.

In another embodiment, the seed containment unit may further have an identification transponder for uniquely identifying the seed containment unit. In addition, the seed containment unit may have a GPS tracking device for tracking the location of the seed containment unit. The transponder and GPS tracking device may communicate with a centralized tracking and identification system.

In another embodiment, the seed containment unit may have a false floor placed between the bottom of the seed containment unit and the air permeable bottom of any liner contained therein. Preferably, the false floor will be connected to the seed containment unit by a hinged connection at the rear wall of the seed containment unit. Thus, the false floor may be raised at the front, forming a ramp tilted toward the rear to assist in the unloading of seed contained within the liner(s). Preferably, the apparatus associated with the false floor for lifting the false floor into ramp position is an inflatable air bladder.

### BRIEF DESCRIPTION OF THE DRAWINGS

FIG. 1 illustrates the logical steps of an embodiment of the present invention;

FIG. 2 illustrates the logical steps of an embodiment of the present invention;

FIG. 3 illustrates the logical steps of an embodiment of the present invention;

FIG. 4A illustrates a seed containment unit of the present invention, including vertically opening top hatches;

FIG. 4B illustrates an embodiment of the seed containment unit with vertically sliding top hatches;

FIG. 5 is a side view of the seed containment unit being off-loaded from a truck;

FIG. 6A is a rear view of the seed containment unit illustrating a liner in the interior chamber of the unit;

FIG. 6B is a rear view of the seed containment unit illustrating two liners in the interior chamber of the unit;

FIG. 7A illustrates the seed containment unit with an aeration tube inside;

FIG. 7B illustrates the seed containment unit with two aeration tubes inside;

FIG. 8 illustrates the seed containment unit with a temperature monitoring device; and

FIG. 9A illustrates the seed containment unit with a false floor and an inflatable bladder which has not been filled with air; and

FIG. 9B illustrates the seed containment unit with a false floor and an inflatable bladder which has been filled with air.

### DETAILED DESCRIPTION OF THE PREFERRED EMBODIMENT

In the description that follows, a number of words are used extensively. The following definitions are provided to facilitate understanding of the invention.

“Agreement” refers to a seed production contract negotiated between a seed grower and a seed production company, which includes a provision whereby the seed grower is permitted to purchase a portion of the seed harvested from a single production field for planting by the seed grower the following cropping cycle.

“Crop data” refers to, but is not limited to, the required information defined in the agreement.

“Cropping history” refers to a record of the crops grown on a given piece of land for at least one year prior to the present year.

“Seed containment unit” refers to the equipment defined in the agreement to retain the selected seed.

“Seed production company” refers to an entity that propagates and/or sells one or more varieties of one or more crops.

“Specified process points” refers to contractually defined stages of varietal crop seed production.

“Varietal crops seed production” refers to the production of the seed of any varietal crop, e.g. wheat, barley, and soybeans.

For the purposes of promoting an understanding of the principles of the invention, reference will now be made to the embodiments illustrated and specific language will be used to describe the same. It will nevertheless be understood that no limitation of the scope of the invention is thereby intended, such alterations, modifications, and further applications of the principles of the invention being contemplated as would normally occur to one skilled in the art to which the invention relates.

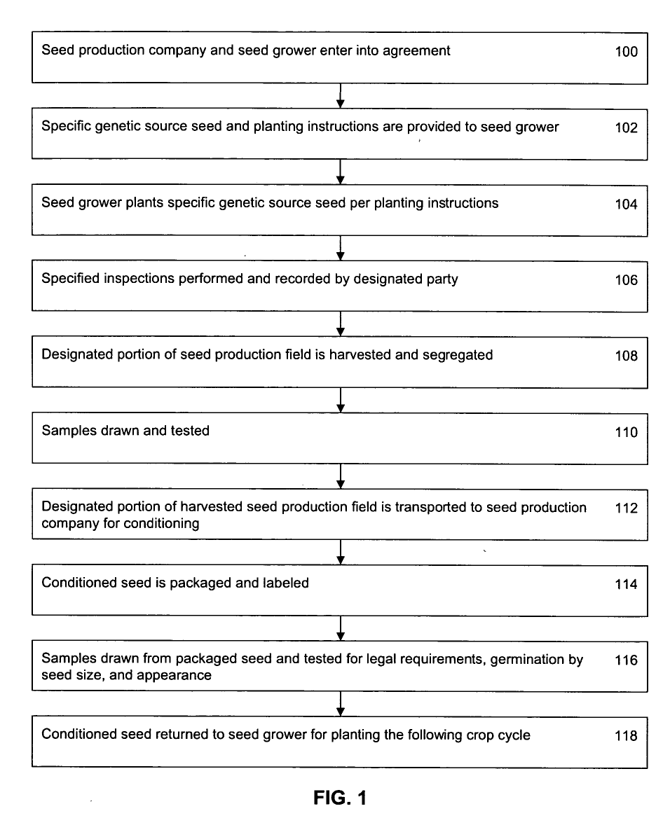

In one embodiment of the present invention, illustrated in logical steps in FIG. 1, a seed production company and a seed grower enter into an agreement for a varietal crop having specific genetics and characteristics (step 100). The seed grower may need to furnish proof of cropping history. As part of the agreement negotiations, the seed grower designates a portion of the resulting seed production as seed to be purchased for planting the following cropping cycle. Specific genetic source seed and planting instructions are provided to the seed grower as stated in the agreement (step 102). If stated in the agreement, the seed grower may be trained by the seed production company to perform and monitor on paper or electronically inspections at certain times and at specific points during the planting, crop growth and harvest cycle of the varietal crop seed production field. If it is not stated that the seed grower will perform these inspections, the seed production company may be responsible to execute and record the inspections either on paper or electronically. The seed grower then plants the specific genetic source seed per the planting instructions provided by the seed production facility (step 104). During certain times at specific points during growth of the seed production field, specified inspections are performed and recorded by the designated party (step 106). The designated portion of the seed production field is harvested and segregated when crop growth is mature per agreement specifications (step 108). Samples are drawn and tested from the stored designated portion of the harvested seed production field and tested by the seed production company or other designated lab for genetic purity, legal requirements, germination by seed size and appearance ratings (step 110). After review of lab testing and inspections results, the designated portion of the harvested seed production field is transported to the seed production company for conditioning per the contractual agreement (step 112). Conditioning, as used herein, can be but is not limited to the cleaning, sizing, color sorting, and other processing of seed in preparation for bagging and distribution. Preferably, the contractual agreement describes the application of seed production company ISO9000 procedures to the seed grower requirements. A representative contract which describes the application of the ISO9000 standards is the I.SOW™ contract prepared by Precision Alliance Group. The conditioned seed is packaged and labeled with identifying information in fifty pound packaged units, 30-50 bushel unit containers or as bulk seed according to the contractual agreement (step 114). Samples are then drawn from the packaged designated portion of the harvested seed production field and tested in the seed production company or other designated lab for the legal requirements and contractual requirements such as germination by seed size, and appearance levels (step 116). After review of lab testing results, the conditioned and packaged designated portion of the harvested seed production field is transported to the seed grower for purchase for planting the following cropping cycle (step 118).

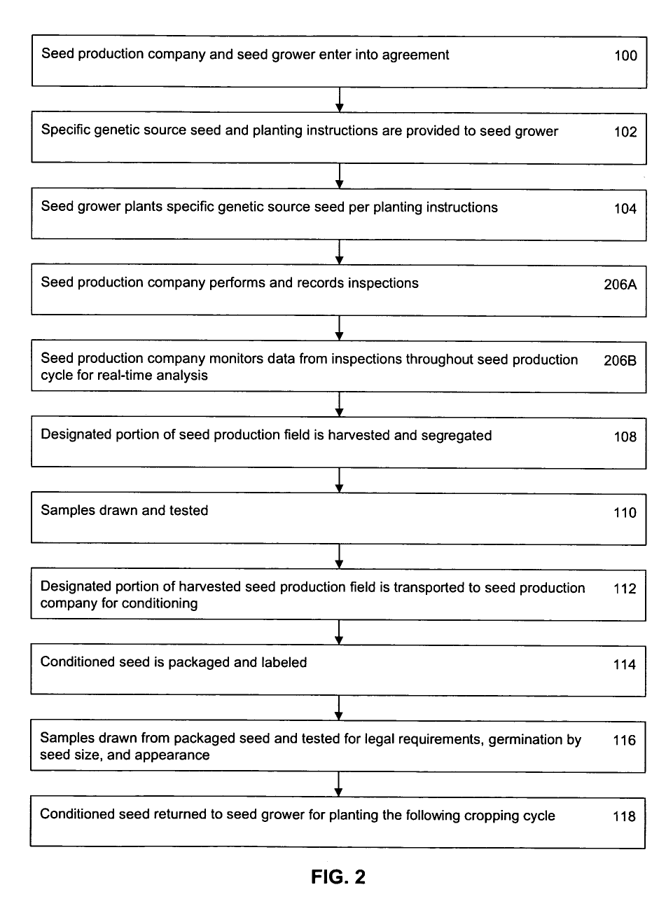

In an alternative embodiment of the present invention, illustrated in FIG. 2, the agreement stipulates that the seed production company will perform inspections throughout the varietal crop seed production cycle for legal and historical purposes (step 206A). The data from the process inspections, along with other pertinent seed grower information, are monitored throughout the seed production cycle for real-time analysis (step 206B). Data record points and inspection documentation can be either paper-based or electronic.

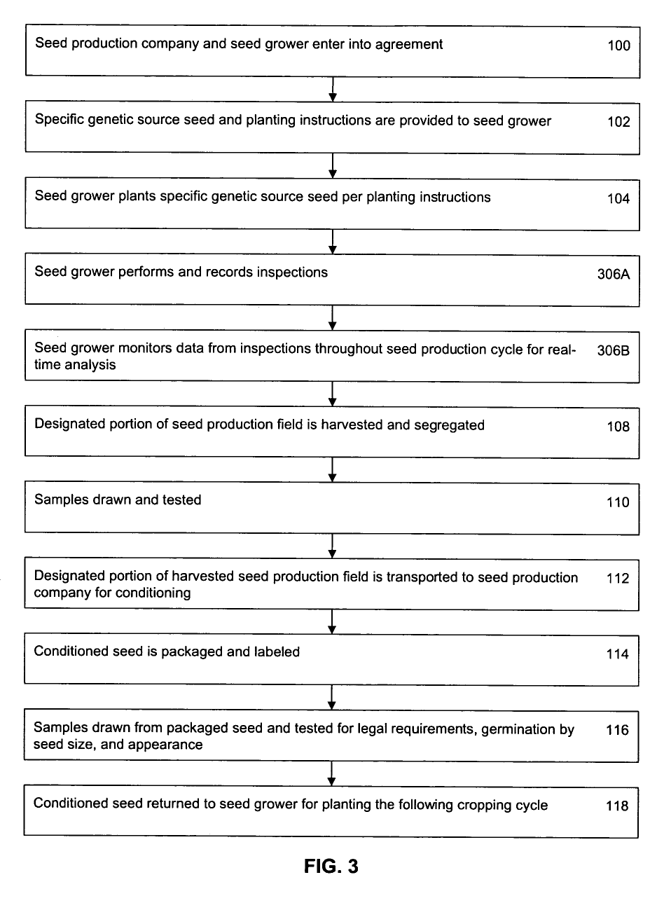

In a further embodiment of the present invention, illustrated in FIG. 3, the agreement stipulates that the seed grower will perform inspections throughout the varietal crop seed production cycle for legal and historical purposes (step 306A). The data from the process inspections, along with other pertinent seed grower information, are monitored throughout the seed production cycle for real-time analysis (step 306B). Data record points and inspection documentation can be either paper-based or electronic.

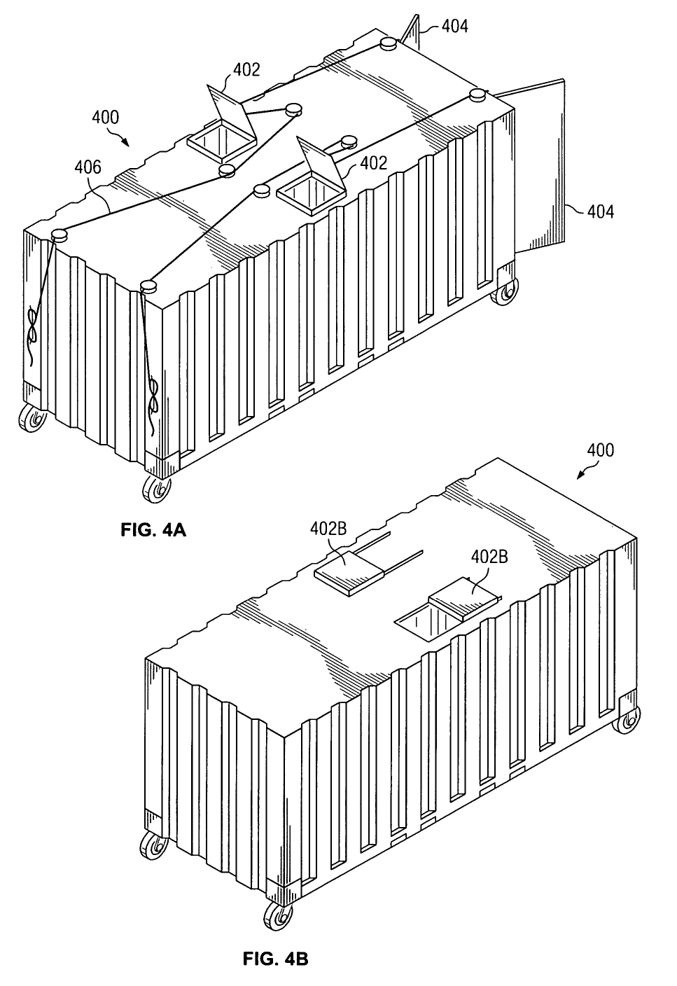

The method of segregating a portion of a seed crop as described above can be implemented with a seed containment unit as described herein. A physical layout of a seed containment unit is illustrated in FIGS. 4-9. The seed containment unit may enable non-transferred delivery of designated seed from the harvest site to the seed production company. The seed containment unit may be the choice of packaging type for designated seed purchased by the seed grower. This seed containment unit may have a unique system for seed loading at the harvest site, unique system for monitoring ambient seed temperature when used as the selected packaging type, and a liner enhancing safe loading and unloading from rear bulkhead. The seed containment unit may have other features facilitating unloading. These features preserve seed quality by reducing handling and contamination risks.

FIG. 4A illustrates an embodiment of a seed containment unit 400 of the present invention. The unit 400 may be constructed of any appropriate materials, such as steel walls on the sides and top and a wood floor on the bottom. Such a unit typically may contain approximately 400 to 700 bushels of seed. The seed containment unit 400 may include one or two top hatches 402 for loading seed and one or two rear-opening doors 404 for unloading seed. Although, as will be described hereinbelow, the unit 400 may include liners for dividing the interior into two sections with the two hatches available for separately loading the two sections, it is preferable for the containment unit 400 to include two hatches even when the interior is not so divided. Two hatches provide increased loading speed and also permit more seed to be loaded with less manual handling. As will be appreciated, less handling may result in less seed damage and contamination. Hatch dimensions of about two feet by three feet are adequate for typical seed loading operations. The seed containment unit 400 may also include unloading doors at the front as well as the back, making additional internal sections more feasible.

The hatches 402 are weather-tight. In the embodiment illustrated in FIG. 4A, the hatches 402 hinge open vertically. However, in order to minimize the impact of any height restrictions, in the embodiment illustrated in FIG. 4B, the hatches 402B have a low-profile configuration, such as by sliding along the top of the containment unit 400.

It will be appreciated that requiring an operator to climb on top of a containment unit 400 to open and close the hatches 402 presents a safety risk. Consequently, the hatches 402 are preferably opened and closed by an operator from ground level. In one embodiment, the hatches 402 may be controlled by cables and appropriate linkages 406 running from each hatch 402 to the front and/or rear of the unit 400. Alternatively, the hatches 402 may be hydraulically or electrically operated by the operator at ground level. Moreover, because a ground-level operator may be unable to see when the hatches 402 are in the fully open or fully closed position, latches or tie-downs may be provided to lock the hatches in one or the other position.

If it is desired to stack multiple seed containment units, risers may be placed on top of the unit 400 to provide sufficient clearance between the stacked units.

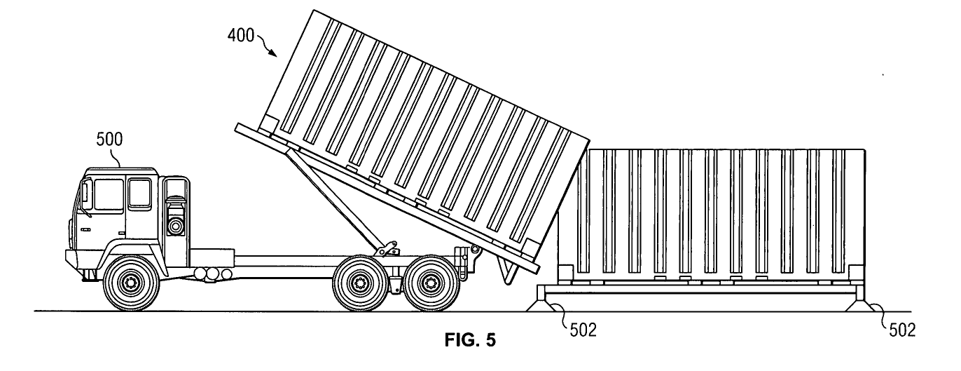

FIG. 5 illustrates the seed containment unit 400 being rolled off of a transport truck 500 and preferably placed on parallel rails or comparable lifts 502. When resting on the rails 502, a conveyor (not shown) is easily positioned at or under the rear of the unit 400 for conveying seed away from the unit 400.

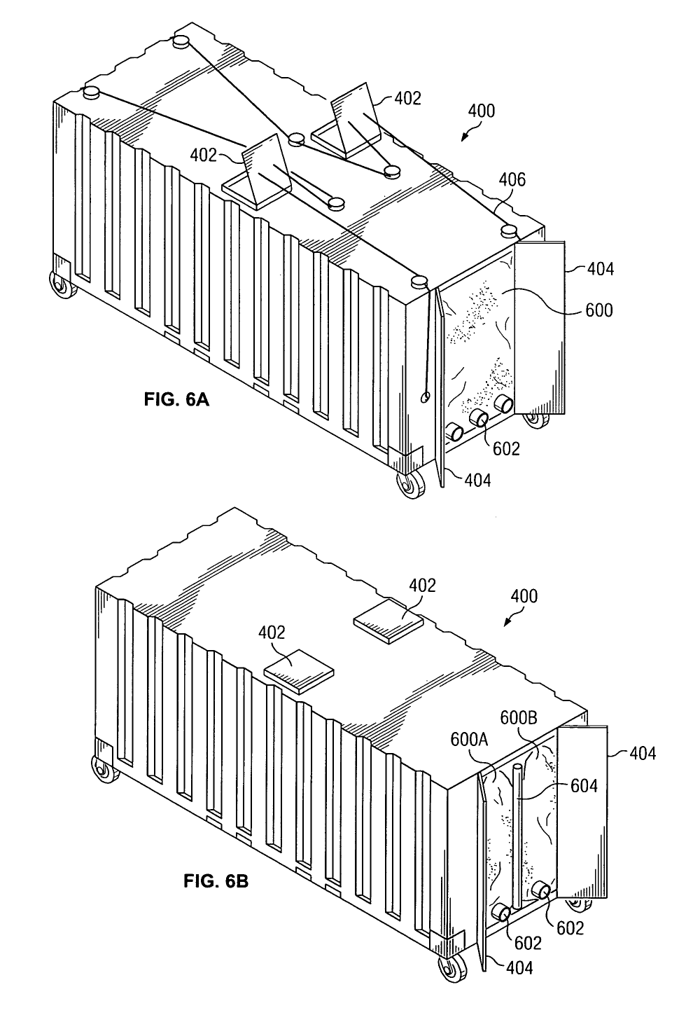

To provide protection for the seed from contamination and excess handling, the present invention also includes a liner for the seed containment unit 400. As illustrated in FIG. 6A, the liner 600 fits inside the unit 400. The walls may be constructed of a vapor-tight material while the bottom may be constructed of an air permeable material; the top may be open to facilitate loading through the hatches 402. Either liner material may be a fabric woven to an appropriate density to achieve the desired tightness or permeability. Woven polyethylene and woven polypropylene are two such materials which may be used. In high humidity regions, a material such as aluminum foil may also be used. The liner 600 may be secured to the inside of the containment unit 400 by hanging it from hooks distributed along the inside top perimeter of the unit 400. Other fasteners may also be used. It will be appreciated that the liner 600 protects the contained seed from contamination and insects and is easier to remove/clean and/or replace than an entire containment unit 400.

The liner 600 includes one or more unloading spouts 602 facing the rear of the containment unit. When the containment unit 400 is being filled or in storage, the spouts are closed (such as by tying them). When the unit 400 is to be unloaded, the spouts are opened and the seed inside the liner flows out. Preferably, the front of the unit 400 is hoisted or otherwise lifted to ensure that all of the seed is unloaded from the liner 600. An alternative method of assuring that the liner 600 or containment unit 400 is adequately emptied which does not involve hoisting the containment unit 400 is described in detail below. As previously described, a conveyor may be positioned to receive the unloaded seed and convey it away from the unit 400.

For space or cost efficiency or for other reasons, it may be desirable to store more than one variety of seed in a single containment unit 400. Multi-seed storage is provided by the present invention by the use of two (or more) interior liners 600A and 600B (FIG. 6B). While the interior walls of the containment unit 400 provide rigid support for three of the sides of each liner 600A, 600B, the fourth walls of each liner 600A, 600B, which are adjacent to each other in the middle of the containment unit 400, may be supported by any type of framework. One such framework includes a set of vertical posts 604 secured to the floor of the containment unit 400 between the two liners 600A, 600B. Preferably, the posts 604 extend in a line from the front of the containment unit 400 to the rear with the liners 600A, 600B filling the two volumes defined by the posts 604 and the unit walls. In such a configuration, the liners 600A, 600B may be loaded with seed through the top hatches 402 and unloaded through one or more rear spouts 602 in each.

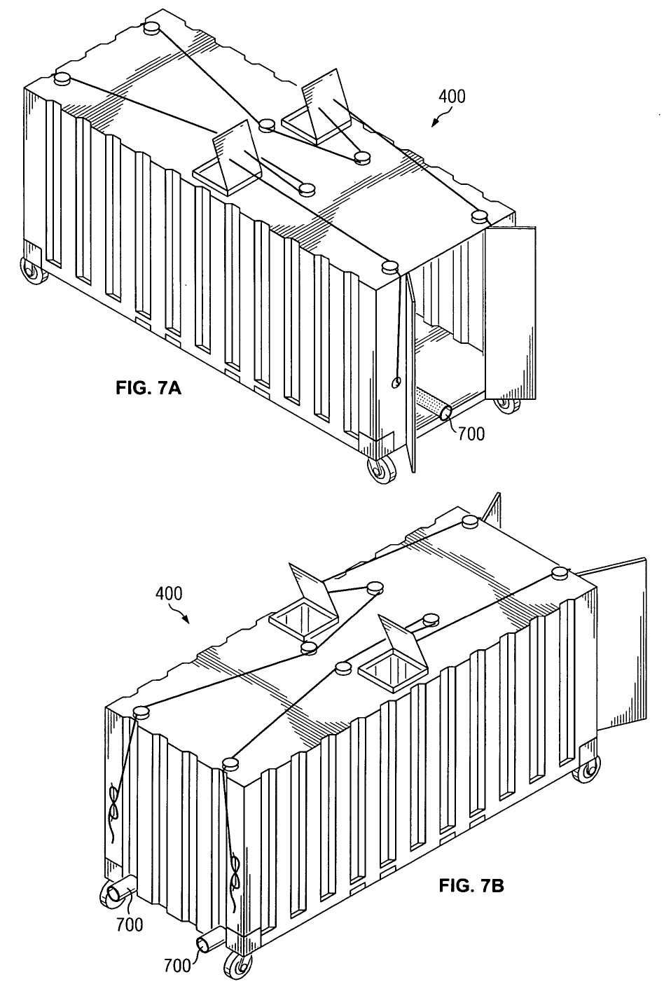

The present invention may also provide protection against the buildup of heat (which may be generated by the seeds) inside the seed containment unit, possibly leading to undesirable condensation. FIG. 7A illustrates an aeration tube 700 extending along the floor of the seed containment unit 400 (FIG. 7B illustrates the use of multiple aeration tubes 700). One end of the tube 700 may be connected to a fan, blower or the like and the portion of the tube 700 which is inside the unit 400 is perforated. The liner 600 or liners 600A, 600B rests above the tube 700. Thus, when the end of the tube 700 is connected to a blower and the hatches 402 opened, air is forced through the perforations in the tube 700, through the bottom of the liner 600, through the seed and out the hatches 402. The direction of the blower may also be reversed to pull air through the containment unit 400 from the top through the open hatches 402. In an alternative embodiment, the blower may connect to the aeration tube 700 through the bottom of the containment unit 400.

In one embodiment of the aeration tube 700, the tube is cylindrical, approximately eight inches in diameter and made of PVC or metal pipe (such as steel or aluminum). In an alternative embodiment, the aeration tube 700 may be trapezoidal in shape with the wider side bolted or otherwise secured to the floor of the containment unit 400. The perforated top side provides additional support to the bottom of the liner 600 which rests on the aeration tube 700.

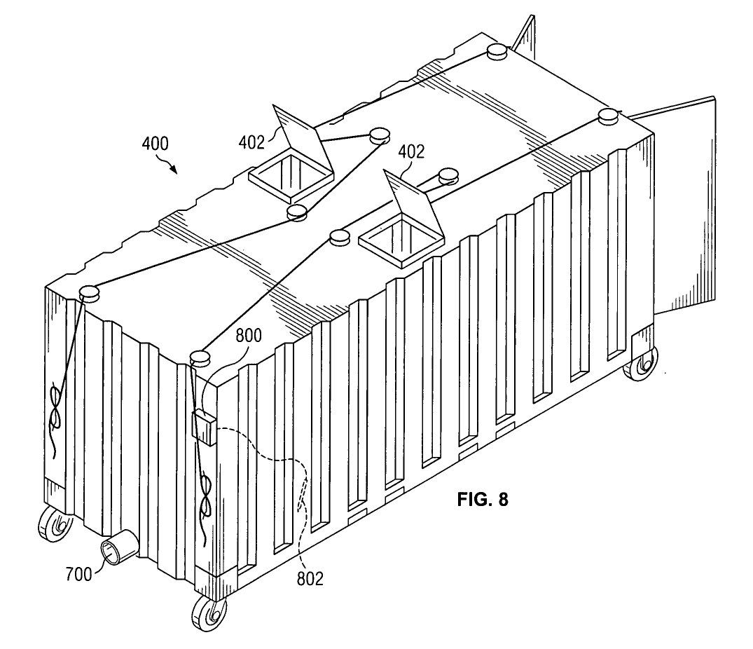

Preferably, the seed containment unit 400 further may include a temperature monitoring system, such as the battery operated device 800 shown in FIG. 8 as being secured to an outside wall of the containment unit 400. A temperature sensing probe 802 is placed inside the containment unit 400 and transmits a signal indicative of the temperature inside the unit 400 to the monitoring system. The signal may be transmitted by a wire connecting the probe 802 with the monitoring system or may be transmitted wirelessly. If the signal is transmitted wirelessly, the monitoring system may be located some distance from the containment unit 400. The temperatures inside any number of such units 400 may thus be monitored from a central location. When coupled to a computer, the temperature may be automatically recorded. If desired, the current temperature and/or the recorded log may be transmitted, wirelessly, by phone or through the internet, to another location.

If an excessive temperature is noted by the monitoring system (or if, the monitoring system is also monitoring the ambient temperature, the inside temperature exceeds the ambient temperature by a predetermined amount), the blower may be automatically turned on for a predetermined period of time or until the temperature reaches a predetermined temperature. Alternatively, an alarm may be activated and the operator will connect the blower to the aeration tube 700, again for a period of time or until it is determined that the temperature has reached a desirable level. When the blower is operated manually in such a fashion, the operator may connect a single blower (or several blowers) in sequence to any number of containment units 400.

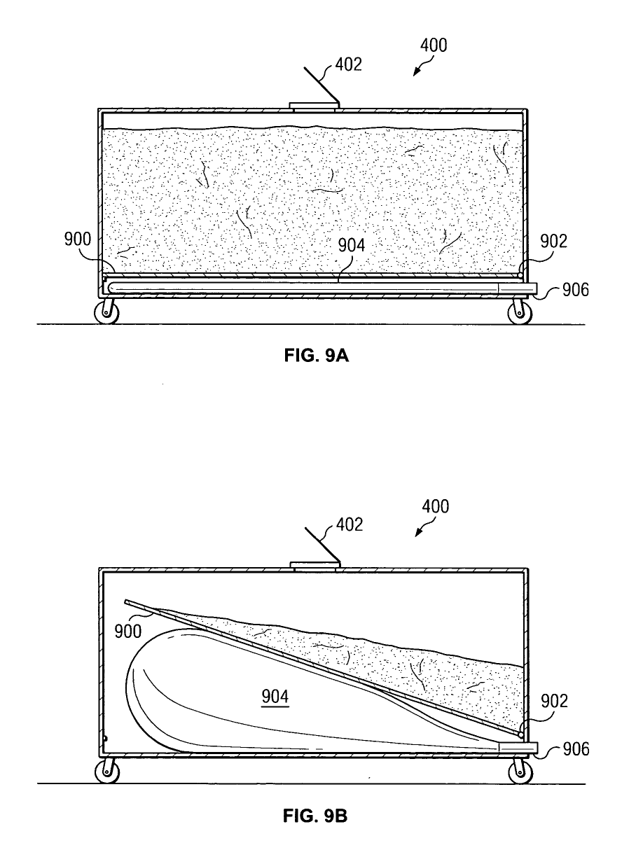

As mentioned above, the unloading of seed from a unit 400 can be enhanced by hoisting, tilting, or otherwise lifting the unit 400 to ensure that all seed is unloaded whether or not a liner 600 is used. Alternatively, as shown in the cutaway views of FIGS. 9A and 9B, the unit 400 may have internal mechanisms which facilitate the unloading of seed placed therein. An embodiment of the unit 400 with an internal offloading mechanism as shown in FIGS. 9A and 9B features a false floor 900 which is connected to the rear wall of a containment unit 400 by a hinged connection 902. The hinged connection 902 allows the false floor to be raised or lowered at the front of the unit 400, thus forming an inclined ramp toward the rear end of the unit 400 facilitating the offloading of seed as shown in FIG. 9B. The false floor 900 may be raised or lowered by any lifting mechanism such as a hydraulic or mechanical jack, however, preferably, the false floor will be raised by the inflation of an air bladder 904. As shown in FIG. 9A, when the unit 400 is being used for the loading or storage of seed, the bladder 904 is substantially deflated and the hinged false floor 900 lies parallel with and substantially adjacent to the actual floor of the unit 400. To facilitate the unloading of seed, the bladder 904 can be inflated through the connection 906 with a source of compressed air or blower. As shown in FIG. 9B, upon inflation the bladder 904 will raise the false floor 900 at the front of the unit 400 forming a ramp which facilitates the offloading of seed. The source of air or blower used to inflate the bladder 904 can be the same as the source of air used to control the temperature of the seed within the unit 400 as described above, or may be a different source of air. The bladder 904 and false floor 900 may be used in conjunction with a liner 600 or liners 600A, 600B, or in a unit 400 without a liner 600.

In further embodiments, the seed containment unit 400 may also include a unique electronic ID transponder, making remote identification of the unit 400 possible. The unit 400 may also include a GPS system whereby the location of the unit 400 may be tracked. The transponder and GPS system for several seed containment units may communicate with a central tracking station over conventional wired or wireless communication devices.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A method of varietal crop seed production wherein a seed grower retains a portion of a varietal seed crop harvested from a single seed production field, comprising the steps of:
a. negotiating an agreement between a seed production company and the seed grower to produce a varietal crop for seed purposes;
b. recording crop data during the growing cycle of the varietal crop;
c. inspecting specified process points by one of the seed production company and the seed grower;
d. delivering a select portion of the varietal crop seed production harvested from a single seed production field to the seed production company;
e. segregating the portion of the varietal crop seed production harvested from a single seed production field in the seed production company's storage;
f. conditioning the portion of the varietal crop seed production harvested from a single seed production field;
g. sampling the conditioned varietal crop seed production harvested from a single seed production field; and
h. returning the conditioned varietal crop seed production harvested from a single seed production field to the seed grower.

2. The method of varietal crop seed production of claim 1, wherein the seed grower records the data.

3. The method of varietal crop seed production of claim 2, wherein the seed grower utilizes a non-electronic means of recording crop data.

4. The method of varietal crop seed production of claim 2, wherein the seed grower utilizes an electronic means of recording crop data.

5. The method of varietal crop seed production of claim 1, wherein conditioning occurs pursuant to an agreement incorporating ISO9000 standards.

6. The method of varietal crop seed production of claim 1, wherein a seed containment unit is utilized to deliver the varietal crop seed production harvested from a single seed production field to the seed production company.

7. The method of varietal crop seed production of claim 6, wherein the conditioned varietal crop seed production harvested from a single production field is returned to the seed grower in the seed containment unit.

8. The method of varietal crop seed production of claim 6, further comprising testing the seed in the seed containment unit.

9. The method of varietal crop seed production of claim 1, further comprising packaging the conditioned varietal crop seed production harvested from a single production field.

10. The method of varietal crop seed production of claim 9, wherein the conditioned varietal crop seed production harvested from a single production field is packaged in fifty pound containers.

11. The method of varietal crop seed production of claim 9, wherein the conditioned varietal crop seed production harvested from a single production field is packaged in 30-50 bushel unit containers.

12. The method of varietal crop seed production of claim 9, further comprising testing the packaged seed.

13. The method of varietal crop seed production of claim 10, further comprising testing the seed in the fifty pound containers.

14. The method of varietal crop seed production of claim 11, further comprising testing the seed in the 30-50 bushel unit containers.

15. A seed containment unit, comprising:
side, front end and rear end walls;
a bottom;
a top;
wherein the front end wall, rear end wall, side wall, bottom and top of the containment unit define an interior chamber, the bottom forming a floor of the chamber,
an unloading door at at least one of the front end wall and rear end wall of the containment unit;
a loading hatch movably attached to the top of the containment unit and operable to selectively cover and uncover an opening formed in the top of the containment unit; and
a first liner comprising sides and an air-permeable bottom, the liner positioned within the interior chamber whereby seed is loadable through the top hatch into the first liner through a first opening formed in the first liner and unloadable through the rear door through a second opening formed in the first liner.

16. The seed containment unit of claim 15, wherein the top hatch comprises a vertically opening hatch.

17. The seed containment unit of claim 15, wherein the top hatch comprises a slidably opening hatch.

18. The seed containment unit of claim 15, further comprising hatch control means for remotely opening and closing the top hatch.

19. The seed containment unit of claim 18, wherein the hatch control means comprises cabling extending from the top hatch to a location on the seed containment unit reachable by an operator standing at level approximately equal to a level of the floor of the seed containment unit.

20. The seed containment unit of claim 18, wherein the hatch control means comprises hydraulic means having a control device reachable by an operator standing at ground level.

21. The seed containment unit of claim 18, wherein the hatch control means comprises electric means having a control device reachable by an operator standing at ground level.

22. The seed containment unit of claim 18, further comprising means for indicating to an operator when the top hatch is in a fully open position and when the top hatch is in a fully closed position.

23. The seed containment unit of claim 15, wherein the sides of the first liner comprise a substantially vapor-tight material.

24. The seed containment unit of claim 23, wherein the sides of the first liner comprise a woven material.

25. The seed containment unit of claim 24, wherein the sides of the first liner comprise a woven material selected from a polyethylene material and a polypropylene material.

26. The seed containment unit of claim 15, wherein the bottom of the first liner comprises a woven material.

27. The seed containment unit of claim 26, wherein the bottom of the first liner comprises a woven material selected from a polyethylene material and a polypropylene material.

28. The seed containment unit of claim 15, wherein the first liner further comprises a rear facing closable spout in which the second opening is formed.

29. The seed containment unit of claim 15, further comprising a second liner positioned adjacent the first liner within the interior chamber whereby seed is loadable through the top hatch into the second liner through a first opening formed in the second liner and unloadable through the rear door through a second opening formed in the second liner.

30. The seed containment unit of claim 29, further comprising support means within the interior chamber positioned between the first and second liners.

31. The seed containment unit of claim 30, wherein the support means comprises a plurality of post secured to the floor and extending from the front of the seed containment unit to the rear of the seed containment unit.

32. The seed containment unit of claim 15, further comprising an aeration tube extending along the floor under the first liner, the aeration tube comprising:
perforated sides positioned within the chamber; and
a tube section positioned outside the interior chamber, the tube section having an opening formed therein connectable to a blower.

33. The seed containment unit of claim 32, whereby:
when the blower is connected to the tube section in a first configuration, air is forced through the aeration tube, out the perforated sides, through the air-permeable bottom of the first liner and through seed contained within the first liner; and
when the blower is connected to the tube section in a second configuration, air is forced through seed contained within the first liner, through the air-permeable bottom of the first liner, through the perforated sides of the aeration tube, and through the aeration tube.

34. The seed containment unit of claim 32, whereby the aeration tube has a substantially round cross section.

35. The seed containment unit of claim 32, whereby the aeration tube has a substantially trapezoidal cross section.

36. The seed containment unit of claim 15, further comprising a temperature monitor to monitor the temperature within the interior chamber, the temperature monitor comprising:
a temperature probe positioned within the interior chamber monitoring the temperature of the seed; and
a monitoring station for receiving temperature signals from the temperature probe.

37. The seed containment unit of claim 36, further comprising an electric cable coupled between the temperature probe and the monitoring station for transmitting the temperature signals therebetween.

38. The seed containment unit of claim 36, further comprising:
a transmitter coupled to the temperature probe; and
a receiver coupled to the monitoring station and operable to receive wireless temperature signals from the transmitter.

39. The seed containment unit of claim 36, further comprising indicator means responsive to the monitoring station and operable to indicate a temperature which exceeds a first temperature.

40. The seed containment unit of claim 39, whereby the indicator is further operable to indicate a temperature which is less than a second temperature.

41. The seed containment unit of claim 36, further comprising a temperature data recording log.

42. The seed containment unit of claim 15, further comprising an ID transponder affixed to the seed containment unit for uniquely identifying the seed containment unit.

43. The seed containment unit of claim 15, further comprising a GPS tracking device affixed to the seed containment unit for tracking the location of the seed containment unit.

44. The seed containment unit of claim 15, further comprising a false floor operatively disposed between the bottom of the seed containment unit and the air permeable bottom of the first liner.

45. The seed containment unit of claim 44, further comprising a hinged connection between the false floor and the rear end wall of the seed containment unit.

46. The seed containment unit of claim 44, further comprising lifting means operatively disposed between the bottom of the seed containment unit and the false floor such that the lifting means may lift a forward end of the false floor.

47. The seed containment unit of claim 46, wherein the lifting means is an inflatable air bladder.
